(19) United States
(12) Patent Application Publication
(10) Pub. No.: US 2010/0306064 A1
(43) Pub. Date: Dec. 2, 2010

(54) Method, system and apparatus for interactive billboard advertising at a live entertainment event

(76) Inventor: Eric Inselburg, Short Hills, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 12/799,858

(22) Filed: May 4, 2010

Related U.S. Application Data
(63) Continuation-in-part of application No. 11/799,139, filed on May 1, 2007, now Pat. No. 7,792,539.
Application No. 11/799,139 is a continuation-in-part of application No. 11/347,993, filed on Feb. 6, 2006, now Pat. No. 7,263,378.
Application No. 11/347,993 is a continuation-in-part of application No. 11/300,208, filed on Dec. 14, 2005, now Pat. No. 7,248,888.
Application No. 11/300,208 is a continuation-in-part of application No. 10/792,170, filed on Mar. 3, 2004, now Pat. No. 6,996,413.
Application No. 10/792,170 is a continuation-in-part of application No. 10/378,582, filed on Mar. 5, 2003, now Pat. No. 6,760,595.
Application No. 10/378,582 is a continuation-in-part of application No. 09/854,267, filed on May 11, 2001, now Pat. No. 6,650,903.
Application No. 09/854,267 is a continuation of application No. 09/656,096, filed on Sep. 6, 2000, now Pat. No. 6,434,398.

(51) Int. Cl. G06Q 30/00; G06F 3/01; G06F 15/16

(52) U.S. Cl. 705/14.71; 705/14.4; 715/733; 709/217

(57) ABSTRACT

A system and method collects and processes data from attendants to a live entertainment event at a venue. The system and method employ a wireless interactive device that is capable of (i) receiving and transmitting messages, (ii) accepting input via a user interface, and (iii) displaying messages on an electronic display. The system includes a sign, which presents to one or more of the attendants, a message with a request to respond back via the user interface. The request is transmitted by the interactive device. A receiving device receives the responses at a central processing station or distributed processing stations. Received responses from one or more of the attendants at the venue are stored as attendant data by a storage device. A central processor is adapted to process the stored attendant data into efficacy data for the sign.

### RELATED U.S. APPLICATION DATA

This application is a continuation-in-part of co-pending U.S. patent application Ser. No. 11/799,139, filed May 1, 2007 which, in turn, is a continuation-in-part of U.S. patent application Ser. No. 11/347,993, filed Feb. 6, 2006, now U.S. Pat. No. 7,263,378, issued Aug. 28, 2007 which, in turn, is a continuation-in-part of U.S. patent application Ser. No. 11/300,208, filed Dec. 14, 2005, now U.S. Pat. No. 7,248,888, issued Jul. 24, 2007 which, in turn, is a continuation-in-part of U.S. patent application Ser. No. 10/792,170, filed Mar. 3, 2004, now U.S. Pat. No. 6,996,413, issued Feb. 7, 2006 which, in turn, is a continuation-in-part of U.S. patent application Ser. No. 10/378,582, filed Mar. 5, 2003, now U.S. Pat. No. 6,760,595, issued Jul. 6, 2004 which, in turn, is a continuation-in-part of U.S. patent application Ser. No. 09/854,267, filed May 11, 2001, now U.S. Pat. No. 6,650,903, issued Aug. 18, 2003 which, in turn, is a continuation of U.S. patent application Ser. No. 09/656,096, filed Sep. 6, 2000, now U.S. Pat. No. 6,434,398, issued Aug. 13, 2002. Each of application Ser. Nos. 11/799,139, 11/347,993, 11/300,208, 10/792,170, 10/378,582, 09/854,267, and 09/656,096 is incorporated herein in the entirety by reference thereto.

### BACKGROUND OF THE INVENTION

1. Field of the Invention

The present invention relates to systems, apparatus and methods for delivering marketing material, tracking its effectiveness and facilitating interactivity between an advertiser and an audience member during activity occurring at a live spectator event; and more particularly, to a system and method by which spectators respond to indicia contained by the advertisement.

2. Description of Related Art

Spectator events, e.g. sporting events and motion pictures, have become a multibillion dollar a year business throughout the world. Millions of people attend their favorite sporting events, choosing among sumo wrestling, baseball, soccer, basketball, hockey, football, tennis, golf, auto racing, horse racing, boxing, block buster movies, etc. These Spectator events can occur at venues of varying sizes, including, but not limited to, theaters, movie theaters, arenas, campuses, college campuses, shopping centers, shopping malls and many other locations. Spectator events can be more than just sporting events and movies, they can include events like Black Friday sails at shopping venues and people going about their business in a college campus. The potential market represented by so many eyeballs has kept advertisers interest for a long time.

Advertising via various forms of signage posted, projected, or displayed in some other fashion, at venues, e.g. sporting venues and movie theaters have been around for decades. Additionally, there have been many advancements in the field, including the use of large electronic displays that allow what is displayed to be changed in real-time without having someone at the sign's location physically affect the change. Mobile billboards that are specifically designed to be driven around have become popular, especially in tourist destinations such as New York City and Los Vegas, Nev. It is estimated that $30.4 billion dollars a year will be spent worldwide on such advertising by 2010.

This figure does not even include signage that is presented to people while they are waiting for an event to start at a theater, e.g., at a movie theater where the signage might be projected up on the movie screen; signage is even appearing within the movies themselves. These, and other usages, of signage by the Entertainment industry have led to new revenue streams and marketing opportunities.

In order to gain access to the “captive audiences” that attend these events, advertisers have allocated for this purpose significant portions of their advertising budgets. However, it is difficult for advertisers to gauge the efficacy of such ads. There has been no practical means to gather data, accurate or otherwise, on the instantaneous or cumulative effectiveness of such advertising audience members at large venues (e.g., stadiums, arenas, racetracks, golf courses, theme parks, airports, and other expansive outdoor/indoor venues). One ineffectual method that has been tried involves asking users where they heard about the advertiser, or their special program. One problem with such methods is that those queried frequently fail to recall where they saw a particular advertisement. Moreover, in today's fast-paced world many find such quires trivial; do not respond to the question, or respond with incorrect or incomplete answers.

With such vast amounts of money at stake, there continues to exist a long felt need in the art for a method and means that accurately gauge the efficacy of such signage. Such information, once attained, would allow companies to better allocate advertising money spent on various forms of signage.

### SUMMARY OF THE INVENTION

The present invention relates to a system and method that facilitates gauging the efficacy of signage. Systems and methods in accordance with the present invention, among other purposes, help advertisers efficiently spend their advertising budgets. They also help property owners gauge the value of their signage.

One exemplary embodiment of the present invention includes a system for collecting and processing data from one or more attendants at a live entertainment event that occurs at a venue. Data collection and processing employs a wireless interactive device that is able to:
(i) receive and transmit messages,
(ii) accept input via a user interface, and
(iii) display messages on an electronic display.
   The system includes a sign, which presents to one or more of the event attendants, a message with a request to respond back via the user interface. An attendee's response to the signage message and request is transmitted by the interactive device. A receiving device receives the response at a central processing station or a distributed processing station. A storage device stores the received answer as attendant data. A central processor processes the stored attendant data into efficacy data for the sign.

Another exemplary embodiment on the present invention comprises a method for data collection, and the processing there of, from attendants of a live entertainment event at a venue. The data collection and processing method employs a wireless interactive device that is able to:
(i) receive and transmit messages,
(ii) accept input via a user interface, and
(iii) display messages on an electronic display.
   The method includes the steps of posting a sign that presents, to one or more of the attendants at a live entertainment event that occurs at a venue, a message with a request to respond back, via the user interface. An attendee response to the signage message and request is transmitted by the interactive device. A receiving device receives the response at a central processing station or distributed processing stations. The received answer is stored as attendant data, and processed into efficacy data for the sign.

Another embodiment in accordance with the present invention is a method for auctioning advertising space. The method includes the steps of collecting raw data about the instantaneous efficacy of one or more sign placement locations. Transmitting the data to one or more bidders as it is collected. Transmitting to the bidders one or more initial auction parameters and subsequent changes to those auction parameters.

One advantage afforded by instant invention is that advertisers, who use signs in any form, are able to confirm the visibility and efficacy of any particular sign at a venue allowing for, among other things, maximization of advertising budgets.

Similarly, the owners of the locations where the signs are posted have the advantage of being able to price their properties based on efficacy of the location.

Another advantage is that different advertisers can bid on how much they are willing to pay to have their message displayed in real time at a specific location. For example, during high profile events such as the Olympics, advertising space is at a premium. Allowing advertisers to bid on locations based on real-time efficacy data can increase the profitability for the location owner. The winning advertiser is advantageously enabled to present their message during times when signage at a particular location is viewed by the most people.

### BRIEF DESCRIPTION OF THE DRAWINGS

The invention will be more fully understood and further advantages will become apparent when reference is had to the following detailed description of the preferred embodiments of the invention and the accompanying drawings, wherein like reference numeral denote similar elements throughout the several views, and in which:

FIG. 1 is a perspective view of a hand-held device used in connection with the interactive participation system of the present invention;

FIG. 2 is a schematic diagram of participants at a spectator event utilizing the interactive participation system of the present invention;

FIG. 3 is a schematic diagram of a system of the invention for enhancing participant enjoyment and interaction;

FIG. 4 is a flow chart depicting an exemplary embodiment of the present invention;

FIGS. 5a-5d depicts several implementations of exemplary embodiments of the present invention at a stadium;

FIG. 6 depicts an implementation of an exemplary embodiment of the present invention on a billboard;

FIGS. 7a and 7b depict implementations of exemplary embodiments of the present invention by the motion picture industry; and

FIGS. 8a and 8b are depictions of a hand-held device used in connection with the interactive participation system of the present invention.

### DESCRIPTION OF THE PREFERRED EMBODIMENTS

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Exemplary embodiments of such architectures include cell phones, smart phones, net book computers, and other devices comprising one or more microprocessors. The various processes and functions described herein may be either part of the microinstruction code or part of the application program (or a combination thereof) which is executed via the operating system. In addition, various other peripheral devices may be connected to the computer platform such as an additional data storage device and a printing device.

It is also to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

It is an object of the present invention to solve the problem of collecting data that can determine the efficacy of different forms of signage, presented via different media at different locations and times.

It is another object of the present invention to solve the problem of real-time analysis of such data, effecting the real-time change of the indicia presented by such signage.

It is yet another object of the present invention to create new methodologies for selling advertising space for signage at different venues, including stadiums, arenas and movie theaters.

It is still another object of the present invention to create a novel method, apparatus and system for the marketing and selling of advertising space on different forms of signage.

It is a further object of the present invention to create interactive signage.

Additional objects and advantages of the present invention shall become apparent upon consideration of the present specification, figures and claims, as originally filed herewith, in their totality.

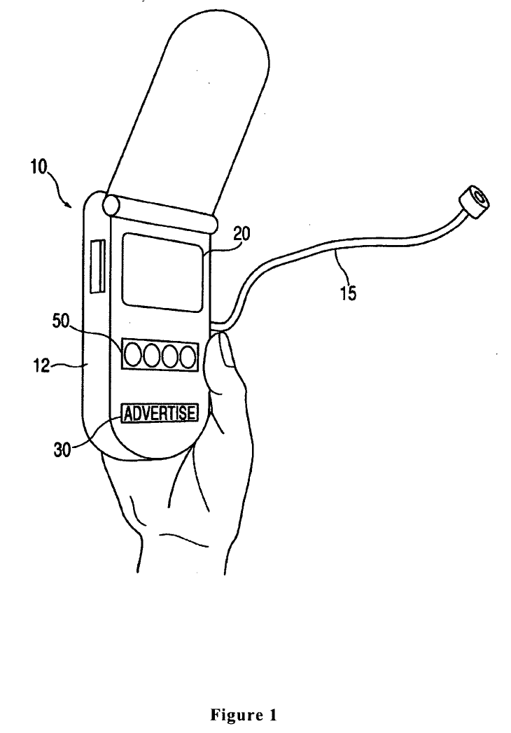

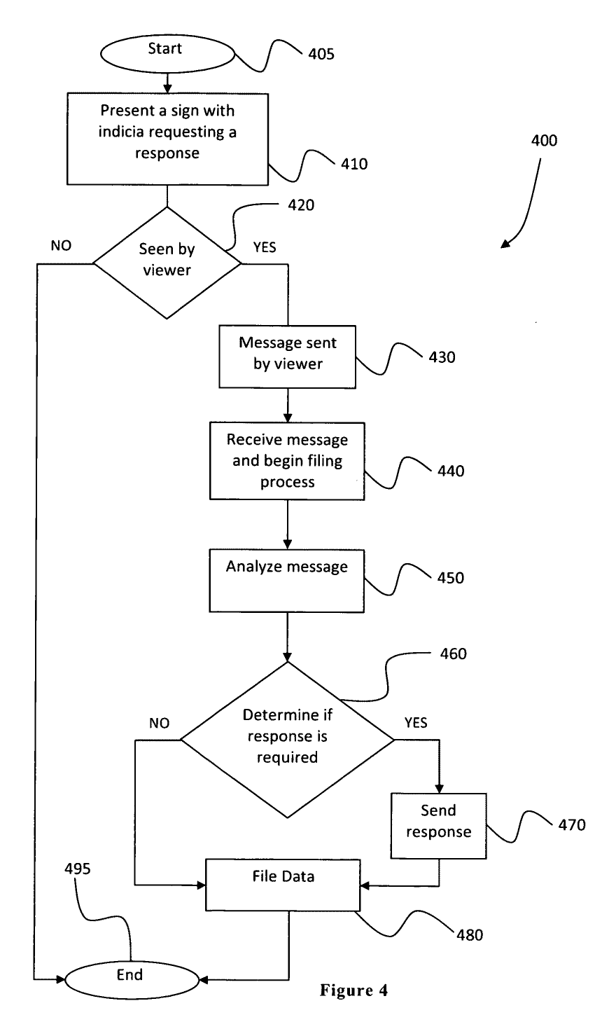

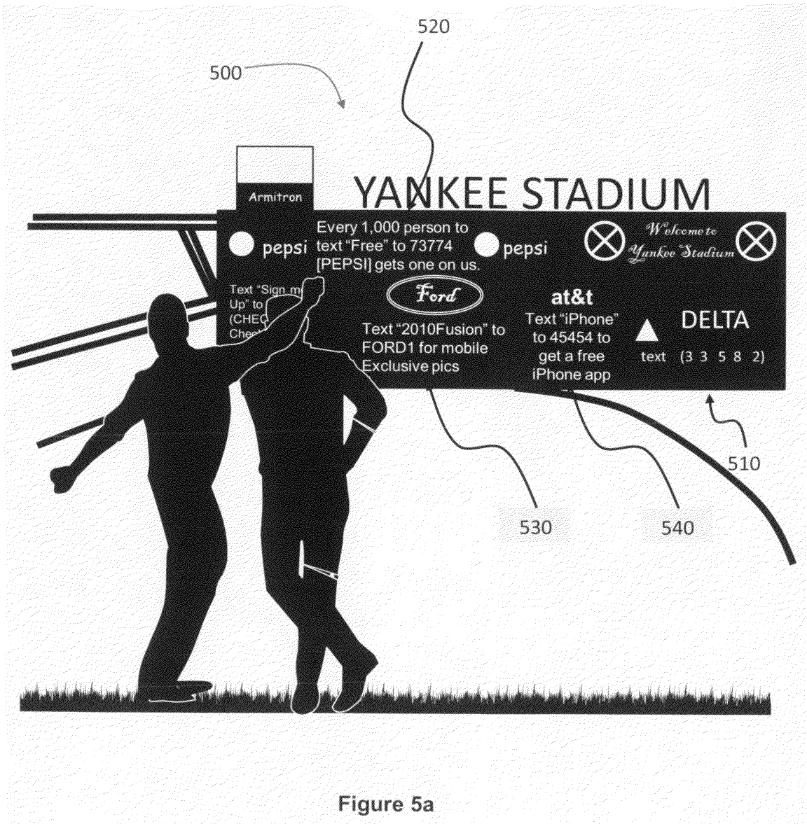

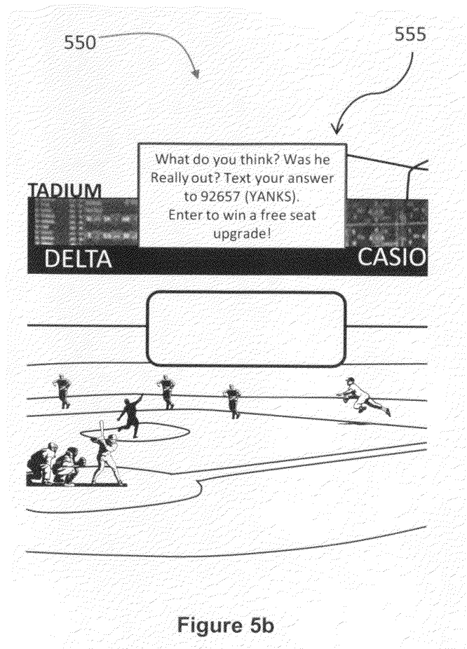

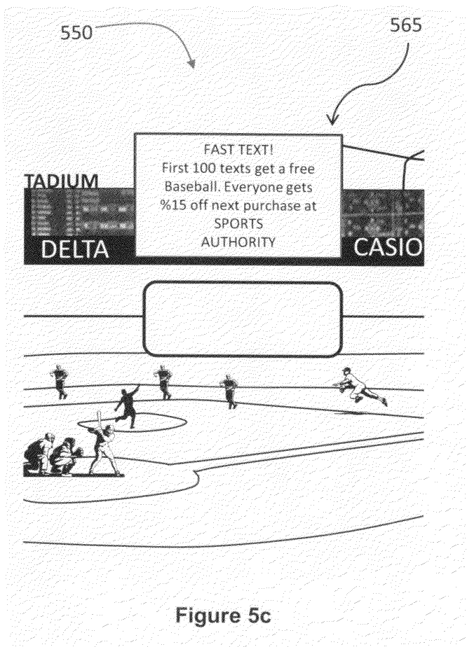

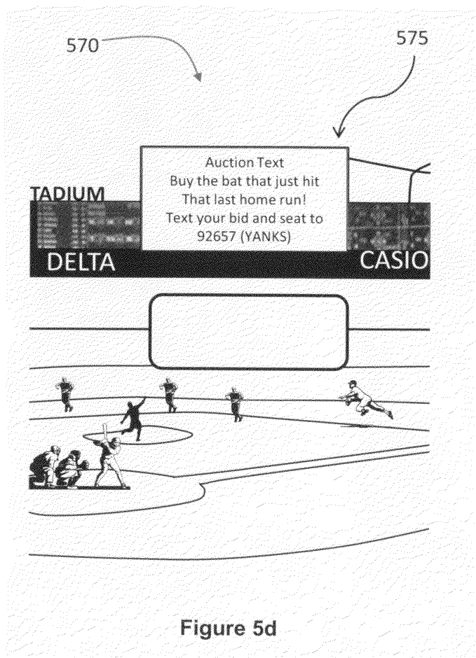

With regard to the figures, reference numerals 10-140 in FIGS. 1-3, in general, indicate apparatus, systems and methods used in connection with the present invention. FIG. 4 and reference numerals 400-495, in general, disclose method steps that are in accord with the present invention. FIGS. 5-8b and reference numerals 500-855, in general, disclose exemplary embodiments in accordance with the present invention.

Referring to FIG. 1, there is shown an exemplary hand-held, interactive device 10 adapted for use in connection with an embodiment of an interactive participation system in accordance with the present invention. The device 10, in other exemplary embodiments of the present apparatus, systems and methods disclosed herein, can include any device that is capable of transmitting and receiving messages over a network, including but not limited to, cell phones, PDAs, pagers and computers. Embodiments of networks in accordance with the present invention can include TCP/IP, TDMA, CDMA and GSM, satellite, and landline based communication systems. Such messages can include, but are not limited to, text, graphical, and other message types, transmitted using the Short Message Service (SMS), Enhanced Messaging Service (EMS) and Multimedia Messaging Service (MMS). For simplicity sake and otherwise noted, it is intended that the term “text message”, and synonyms thereof, shall refer to any message, regardless of type or mode of transmission.

The bidirectional wireless communications used in the practice of the present method and system are preferably implemented using at least one transmission form selected from the group consisting of radio transmissions, microwave transmissions, broadband wireless data transmissions, and satellite transmissions. Ultra-wide band and spread-spectrum transmission are especially promising technologies for the broadcasting of messages and transmission of participants' responses. The multiplexing and frequency shifting inherently available in such technologies improve immunity to noise and interference, and the security of data in transmission. For example, suitable techniques which may be used in the implementation of the present system are practiced in connection with cellular telephone systems, including such currently preferred methods as frequency division multiple access (FDMA), time division multiple access (TDMA), code division multiple access (CDMA), and global system for mobile communications (GSM™) protocols, as well as other protocols including those defined by the International Telecommunications Union. Especially preferred are implementations of the present method compliant with interoperability standards promulgated by the Open Mobile Alliance and made available at the website www.openmobile.com and by the WAP Forum at the website www.wapforum.com. It is also preferred that access to the interactive features of the present invention be provided to customers of more than one provider of wireless services, including providers of cellular telephone service or of wireless access for PDAs and Pocket PCs. In some embodiments, such access for participants employing wireless interactive devices served by a plurality of providers is provided by a wireless communications system wherein network connection of plural providers permits needed exchange of information, e.g. via the Internet. In other embodiments, the wireless communication system comprises one or more authorized providers of wireless service. Participants employing wireless interactive devices served by another wireless service provider are furnished an access code, such as a telephone number and optionally further codes, or the like, permitting them to connect to one of said authorized providers, whereby they are enabled to participate in the present method, being afforded access to the various features described herein.

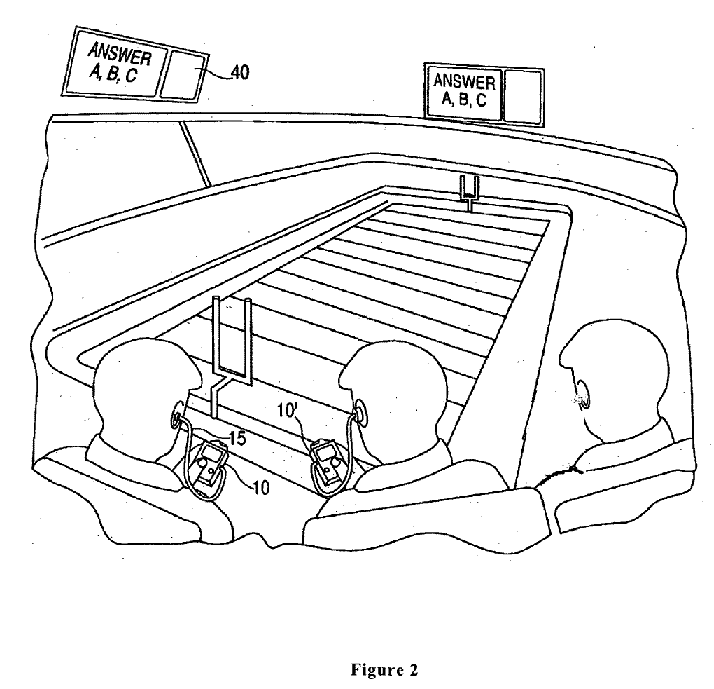

In one embodiment, device 10 is employed by audience members at a live spectator event as shown in FIG. 2. The device is adapted to communicate bi-directionally with a wireless communications system operative at the event), to provide information to a user, and to accept entry of information through a user input interface for transmission to the wireless communications system. In a preferred embodiment, the device 10 includes a housing 12 with an electronic display opening. An electronic display (visual display) 20 providing one form of user output interface is preferably mounted within the housing and is visible through the electronic display opening therein. The electronic display may be of many types, e.g. employing liquid crystal or electroluminescent displays. The electronic display is in electrical communication with a local microprocessor mounted within the housing. A transceiver in electrical communication with the local microprocessor allows for the transmission and receipt of data from a wireless communications system connected to a central processor (not shown) in a manner known in the art. The electronic display is adapted to output information received from the local microprocessor, such as graphic or textual messages that ask the participant to answer a question, provide an opinion, or convey other important information. It is contemplated that data in the form of audio messages could be sent to the user in lieu of or in addition to the visual display. The visual display may be limited to presenting alphanumeric messages, but more preferably is capable of displaying graphical, pictorial, or streaming video input at various scan rates, preferably in real time. Keypad 50 accepts user input for transmission to the central processor.

Spectators at live entertainment events have come to prefer the present accessibility of information. If a spectator, say for example at a soccer match, wants a clarification of the rules, they will often access this information from the Internet via some form of a portable communications means or via connected terminals provided at the venue. More or less, whatever information a spectator might require, will be available via accessible networks like the Internet, even if such information is not related to the presently occurring event.

Applicant has recognized that the ubiquitous access to information and the proliferation of the Internet, and its ability to bring together people from all over the world, have led to a desire for instantaneous interactivity. The proliferation of text messaging via cell phones and the advent of interactivity gateways like TWITTER™ have further fomented this desire. From Senators and Congressional Representatives twittering during a State of the Union address to protestors, in other countries, protesting the results of elections, instantaneous interactivity is becoming an integral part of human society all over the world.

The Applicant has further recognized that in addition to interactivity with other spectators at live events, the spectators of an event would also like to interact with advertising sponsors that advertise at these events. The Applicant has further recognized that this desire for interactivity and information, among other things, by spectators of live events could help solve the problem of gauging the efficacy of the advertisements presented in proximity to the venues. Applicant has also recognized that if real time data for the actual visibility of particular signage at a venue could be generated, then this information could be used to create a real time marketplace for sale of add space in real time, and that embodiments of such a marketplace could take the form of an auction.

The data collected would be an actual representation of the number of “eyeballs” that have physically viewed the sign, and have been affected sufficiently by the content therein to respond in accordance with the indicia on the sign. This data, combined with statistical analysis methods, can be used to estimate the number of people that have actually have seen the sign. Such analysis can be facilitated by using additional data such as average attendance at a venue or event, which is representative of the number of actual people that were present at the event or venue.

Inasmuch as this data can be collected and distributed in real-time, the data can be used to set up an advertising space auction. In one exemplary embodiment of such an auction, in accord with the present invention, the raw collected data, or calculates therefrom, would be communicated (using one or more networks, satellites, cellular system, traditional telephone systems and other communications system). The potential advertisers would also receive other information including starting price, current bid price and bid history. The winner of the auction would be given the ability to place, immediately, their message on the sign, where such change is effected automatically or by physical human intervention.

Other embodiments of the present invention chart the efficacy of an advertisement based on how many people actually respond, or statistically have seen, the advertisement. Such a pricing scheme can allay fears that advertising dollars are being wasted by ineffective advertisements.

One exemplary embodiment of the present invention further expands a provided infrastructure for a method, in accordance with the present invention, for enabling interactive participation at a live spectator event by a plurality of participants employing a wireless interactive device. The interactive participation may enhance the enjoyment of such participants at a live event transpiring at any form of entertainment venue. The expanded functionality is provided in the form of text messaging indicia that has been added to signage. Such text messaging requests that the spectator send a text message to a specific number in order to initiate a communication with the sponsor of an advertisement, or an entity acting on behalf of the sponsor. Exemplary embodiments of such indicia can be seen in FIGS. 5a-5d, reference numerals 510-540, 555, 565 and 575. Such indicia can indicate specific rewards that will be presented to the viewer of the signage upon their transmission of a specified response to a specified number, as indicated by signs 520-540. Other exemplary indicia can comprise a request, as depicted by signs 555 and 565, entry into a contest with the optional indication of one or more of prizes that might be won. Other exemplary indicia can comprise, as depicted by sing 575, a request for purchase. The indicia can also comprise a request, as indicated by sign 510, for a transmission from the viewer, without any specific indication of the “benefit” the viewer might receive in return. Other indicia can be indications of how different authorities at a specific venue might be contacted. A sign might contain information about what message should be sent to the facility's officials. For example, an attendant that can be surreptitiously called when another attendant gets a bit rowdy. As another example, a sign can indicate how the attendant, for delivery to his seat when ready, can place an order for food or drink.

Some forms of entertainment are associated with specific and defined programmatic content having an identifiable duration, such as the content provided by an athletic event, a musical or theatrical performance, or the like. On the other hand, entertainment may be provided to individuals as a consequence of patronizing a museum, casino, cruise ship, shopping mall, theme park, agricultural fair or similar exposition, a trade show, convention, or the like. Persons present on a college or university campus also experience such entertainment as well as other campus related activities. The entertainment provided in such situations and activities may or may not include specific programmatic content having a generally defined duration as part or all of the activity. In some instances, the totality of entertainment activities has a duration bounded by opening and closing hours of a museum, mall, park, fairgrounds, convention hall, or the like. In other forms of entertainment, e.g. at casinos, activity often continues around the clock. It is to be understood that the present invention relates to entertainment forms either with or without the foregoing specific programmatic content and defined duration. For entertainment forms without defined duration, the present activity is bounded, with respect to any particular individual, by that individual's active or passive participation in any form of entertainment, instruction, promotion, activity, or other conduct ordinarily associated with the particular type of venue.

For example, at a trade show, an attendee is normally provided with commercial or technical information or promotional information involving goods or services offered by exhibitors at the show. It is to be understood that dissemination of such technical or promotion information constitutes entertainment within the meaning of that term, as used herein, and the duration of the event is understood to be defined generally by the attendee's presence at the venue. Similarly, a casino is often associated with a venue that includes a gaming area in which persons engage in any of a variety of games of chance or gambling, as well as other appurtenant areas providing restaurants, shops selling various forms of merchandise, theaters or auditoriums (e.g., providing live stage entertainment or activity), public gathering areas, and hotel accommodations.

The principles of the present apparatus, systems and methods also find application in venues of yet other types. For example, shopping is perceived by many as being a form of entertainment, in that such persons find diversion, amusement, or otherwise agreeable occupation in such activity, transcending the mere utilitarian function of acquiring essential or desirable articles. Such activity is especially enjoyed in the context of large shopping venues, such as large, freestanding stores known as “big box” stores, and large department stores offering many diverse types of merchandise and services. Shopping malls or centers in which are situated a plurality of individual stores are venues even more attractive to some. These facilities may comprise one or more large indoor buildings including plural stores with interior access, or a plurality of buildings connected by exterior or interior walkways. Either indoor or outdoor entrances may provide access to individual stores.

Large malls now frequently provide a multitude of different experiences beyond retail sales of goods, including, for example, restaurants, movie theaters, auditoriums, or public spaces for artistic or cultural events. At least one large shopping center even houses an indoor theme park with various amusement rides and the like. Ordinarily, shoppers are free to come and go at a shopping venue without admission charge or control. However, certain entertainment events or other functions or amusements therein may require an admission fee.

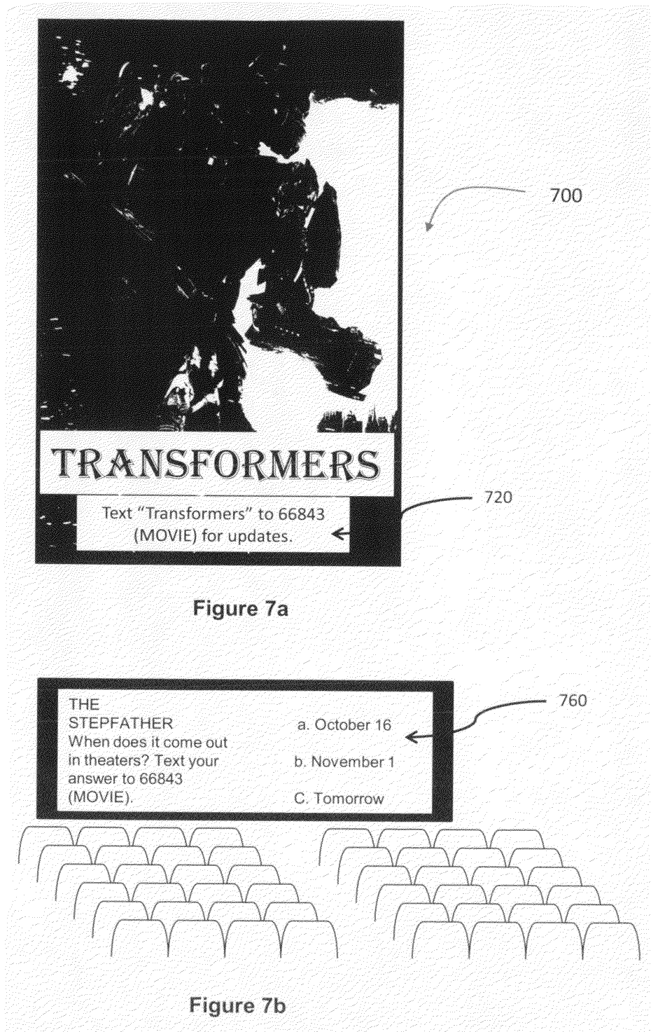

Two such exemplary embodiments, in accordance with the present invention, are depicted in FIGS. 7a and 7b. One of these embodiments is a movie poster 700 that might be placed in the vestibules of movie theaters. If an attendee sees the poster and is interested in the movie presented, they can send a text message as indicated by indicia 720. FIG. 7b depicts a movie theater viewing area 750 displaying indicia 760 during the time between showings. Such displays can be considered another form of signage, similar to LCD monitors that are used in many sporting venues today. Attendees waiting for a show to start might view the message 760 and decide to respond as indicated by the indicia 760. Once the attendee sends the message as indicated, they can be considered enrolled members.

In embodiments of the present invention, once the messages are received by the advertising system that is in accordance with the present invention, a response can be sent. For example, the attendees might be asked if they were thirsty. If they respond in the affirmative, an electronic discount coupon might be sent indicating that they can get a discounted beverage at the concessions area of the theater. Such a message can entice the attendee to spend additional money, when they might not normally do so, increasing the profitability of the movie theater.

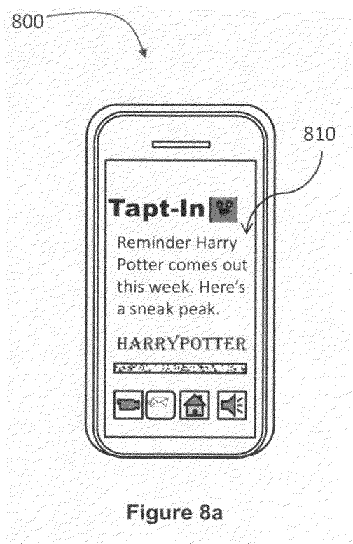

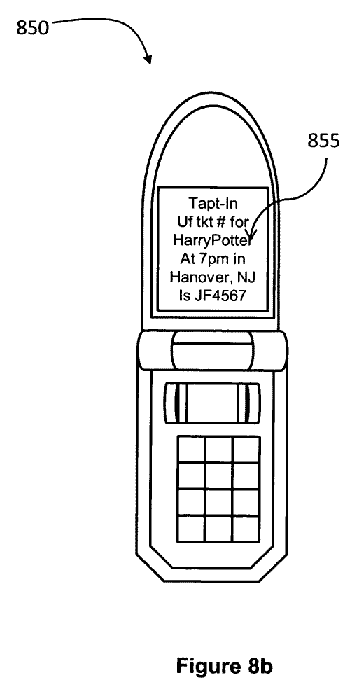

In another exemplary embodiment, as enrolled members, additional messages can also be sent to the attendant/member, even if they are no longer within the venue. One such message 810, regarding a new movie that is about to be released, is depicted in picture 800 of FIG. 8. As indicated by the message 810, the attendant/member can also be given access to additional material, for example, movie trailers.

Additional exemplary messages sent to the attendant/member can include information, reviews, trailers, insider information, show times, show locations, insider information regarding sequels, opportunities to purchase merchandise e.g. soundtracks, and available discounts e.g. for available for tickets all can be sent SMS message or other means. In additional optional embodiments of the instant invention can be used to send tickets, purchased by the attendant/member or gifted to the attendant/member can also be sent via SMS messages, or other means, as depicted in picture 850 by message 855 in FIG. 8b. Interactive ads offering discounts and request for movie alerts sent via SMS or some other means could also be sent by advertisers to the attendant/member. In other embodiments of the instant invention important information can be sent to the attendant; for example, such information can include “Find your seat, the show is about to start” or some form of security announcements. In another exemplary embodiment of the present invention periodic messages indicating a countdown to the start of an event can also be sent to attendant/member. It should be noted that thought the examples given herein above related to movies, the artisan of ordinary skill would be able to adapt such messages for any type of event, without requiring excessive experimentation.

In other embodiments in accordance with the present invention, signage with the appropriate indicia can be placed within the movie itself. When the attendees respond as indicated, they can receive additional information that might not be available to the other attendees who have not responded. For example, a matchbook from a restaurant might be found by one of the movie's characters at a crime scene. As evidence might contain indicia that requests a message be sent. If the attendee sends a message as indicated, they might receive additional information regarding the restaurant, and which might be visited by that character. The attendees can thus interact with the movie, providing the attendee with additional entertainment value. The messages sent to the attendee can also contain advertising information. This interactivity can also occur when a group of friends is watching the movie via some form of recorded media, like DVDs, being played at home, increasing the advertising possibilities that are available.

It is also to be understood that the activities and events for which the present apparatus, methods and systems are suited, whether or not they involve events having defined programmatic content, typically extend beyond narrowly defined temporal and spatial limits. For example, live entertainment events often occur in a building with defined entrances or an indoor or outdoor area demarcated by fences or other barriers with defined points of entry that may comprise gates, turnstiles, or the like. Many live events take place in a stadium, arena, theater, or auditorium having defined spectator seat locations, e.g. seats uniquely denoted by section, row, and seat numbers or the like. In addition to the actual performance area (such as a playing field, concert stage, or movie theater) and the appointed spectator area, event facilities ordinarily have auxiliary or appurtenant public areas associated therewith. Such areas provide facilities and services that are desirably or essentially associated with the live entertainment event. The auxiliary areas are generally adjacent or in close proximity, and may include non-exclusively: ticket windows; passageways; rest rooms; clubs; restaurants; concession stands selling food and beverages; lounges; overflow areas with audio and/or video links to the principal event area; shops selling souvenirs, promotional merchandise, novelties, or related items; and service facilities such as parking lots and stations for public transportation; and the like. For example, patrons at an athletic event frequently engage in social activity in a venue's parking lot before or after the event, often including the consumption of food and beverage, a practice commonly known as “tailgating.” Such activity bears a clear thematic relationship to the athletic event itself, since there is ordinarily extensive conversation about the event, the competing teams or players, or the like. Similar activity is common in connection with concerts and other live spectator events as well.

The principles of the present apparatus, systems and methods also find application in venues of yet other types. For example, attendance at a college campus is perceived by many as being a form of entertainment, in that such persons are offered the chance to participate in and/or spectator a large variety of campus activities, including educational offerings, research projects, student government, Greek life, dining, varsity athletic games, intramural sports, student clubs, theatre performances, on campus dating, social functions, dormitory life, and the like. During such activities, it is likely that they will come upon signage that requests a message be sent to the sponsor. The college campus experience offers a multitude of activities to participate in and/or spectate. College campuses typically have a large number of buildings, fields, and “quads” where students, faculty, and visitors interact in person. Most college campuses further have a stadium, basketball courts, tennis courts, football fields, baseball fields, theatres, exercise facilities, tracks, lecture halls, office buildings, dormitories, dining facilities, parking lots, and the like. Further, most college campuses have a defined border that defines the boundary of the campus, wherein most buildings and other facilities are located within the campus boundary—this being known as “on campus”. In one embodiment of the present invention, the term “college campus” means within the campus boundary. In another embodiment of the present invention, the term “college campus” means that the activity is related to the college or university, but does not necessarily have to be within the campus boundary. For example, some colleges offer “off campus” housing. Other colleges utilize an “off campus” facility for some of their varsity athletic teams games (i.e. Seton Hall University hosts its varsity home basketball games at the Continental Airlines Arena in East Rutherford, N.J.). Other examples exist for “off campus” activities that are directly related to the college.

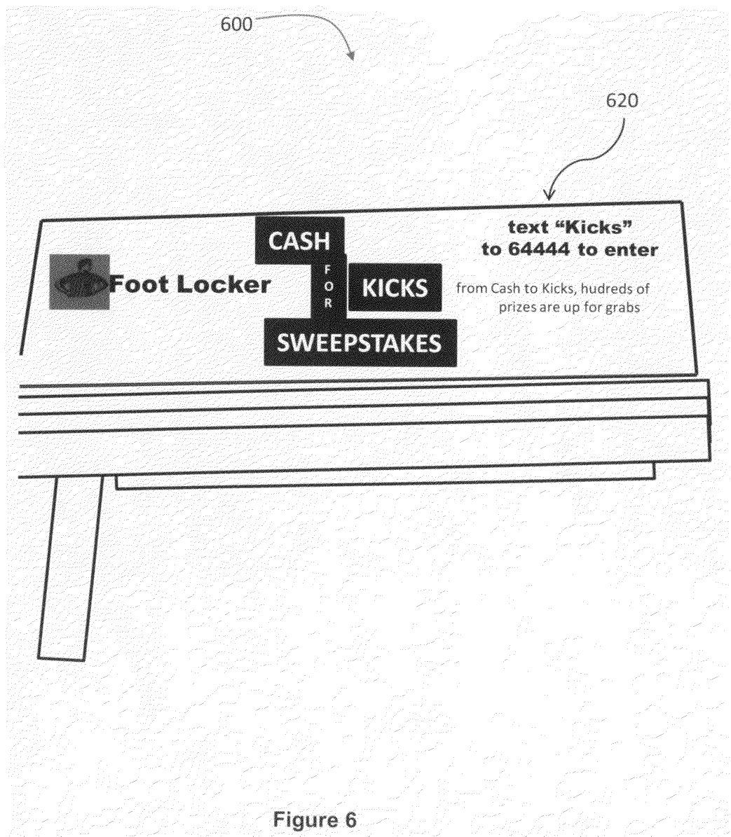

It is thus to be understood that the term “venue” as used herein with respect to the activities and events discussed above, whether or not they include specific programmatic content and defined duration, extends to a penumbra defined by its relationship to such activities and events. Participation in the present interactive method may be afforded to persons in the primary area of the activity as well as in any of these penumbral locations, all of which are to be understood as collectively included in the term “venue” as used herein. Such auxiliary areas of a venue as parking lots, lawns, walkways, and the like are to be understood as included as well. It is also to be understood that the present interactive participation may involve activity at any location within the venue. For example, picture 600 in FIG. 6 is an example of a billboard that one might see in the parking lot of a sporting arena. Many people arrive before the main event starts and engage in an activity like tailgating, which can be considered a type of party/event held outside the stadium. While interacting with the other attendees they might see the sign comprising indicia 620 and respond as indicated, providing additional advertising possibilities.

In embodiments of the present invention, the interactive device is optionally used by participants to receive audible or video programming that comprises indicia in accord with the present invention. Such programming may be transmitted in the commercial AM or FM broadcast band or at any of a number of predetermined frequencies in the RF, VHF, UHF, or microwave frequency bands, or via physical connection to the interactive devices 10. The transmission may be analog or digital. Programming may also be transmitted optically, such as by modulation of an infrared emitting source located in the venue and received by a complementary photoreceptive element in the wireless interactive device and suitably processed for intelligible output. Optionally, the device also comprises means for receiving and displaying video signals such as from ordinary broadcast television stations. Transmission of such program content may be done via conventional commercial broadcast stations or with low power transmitters intended only to cover the immediate event venue. Transmitters are optionally located either within the venue, in its environs, or in any other location that permits a sufficiently intense signal to be present in the venue. In a preferred embodiment device 10 incorporates circuitry to receive the aforementioned audio or video program content. The circuitry is adapted to receive the content and present it to the user. An earpiece 15 is preferably included to allow the user to listen to the audio content associated with the device without annoying others nearby. It is noted that other listening means could be employed such as earphones, speakers, or the like.

In other embodiments the aforesaid audio or video programming may be transmitted via any computer network to which the interactive device is connected, such as by streaming audio or video transmitted via the Internet, time division multiple access (TDMA) networks, code division multiple access (CDMA) networks, or Global System for mobile communications (GSM) networks in accordance with presently employed protocols or other suitable protocols.

Such audio or video programming preferably comprises information or program content that is thematically pertinent to the event or venue or provides content otherwise useful to the participants. For example, on a university campus, such material might include news relating to the institution's athletic teams or other cultural or intellectual events in the life of the university community. At a shopping mall, the content might include shopping promotions, announcements, or coverage of other entertainment occurring on the premises. The content may include descriptions of the action at the event, related expert commentary or instant replays. The content optionally includes other information of interest to participants, such as news and traffic reports and weather conditions and forecasts. Furthermore, the audio or video programming may include dissemination of questions or other matter incident to contests and polls conducted in accordance with the invention.

The present method preferably employs at least one unique signature of each wireless interactive device, whereby a given participant's entries and responses may be individually attributed and tracked and the various interactive features described herein may be individually or collectively implemented. In addition, an electronic account is frequently associated with each user-supplied device for charges and credits. In some of the embodiments of the present invention, charges are levied for goods and services provided and transferred to the account associated with each device. Likewise, monetary credits, coupons, and the like can be disseminated either electronically to the account or by mail to an address associated with the account.

In addition, it is preferred that information establishing each participant's location within a venue also be associated with that user's device. The association can be effected in many ways. Preferably, a given user is provided during the enrollment process with one or more identifying indicia that can be entered using the user input interface of the device and included in the unique signature transmitted by the device. For example, participants may be provided with indicia distributed beforehand or upon a request that is entered through the wireless device, e.g. through wireless connectivity to the Internet. Indicia may be provided by regular mail, e-mail, telephone text messaging, by connecting with an appointed Internet site, or any other suitable means. The foregoing features by which users are individually identifiable also permit the various services to be offered selectively to qualified, appropriate, or interested participants or groups of participants.

Many of the wireless devices useful in connection with the present system, such as cellular telephones, now include localization circuitry. One form of such circuitry relies on global positioning system (GPS) technology. The device is thereby enabled to determine its geographical position quite accurately and transmit a position identification signal under appropriate circumstances. In an aspect of the invention, the present system includes location-receiving circuitry, such as that provided by a wireless service provider, capable of receiving position identification signals from a wireless device and thereby determining whether a particular wireless device is within a preselected, geographically delimited operational zone. For example, this functionality is optionally used to ascertain whether a given device is on the premises of a venue such as a shopping center, a university campus, or a theme park.

As there are many suitable alternatives on which to base an embodiment of the current invention which are known to those skilled in the art, the specific interactive device and wireless communications technology used, the specific multiple access communication protocol used, and the specific client/server hardware interface and protocol are of lesser importance to the method of the invention so long as they support the required functions. What is important is the method of this invention by which the customer is provided better service.

It will be understood by one skilled in the relevant art that different transmission modes and frequencies may be used by the wireless communications system for the transmissions to and from the wireless interactive device and that multiple transmission modes and frequencies may be used to accommodate interactive devices of different types simultaneously operated in the present system.

In one aspect, the present method includes the step of providing a wireless communication system adapted to transmit and receive messages with the wireless interactive devices used by the participants. The wireless system is used to disseminate promotional messages to the participants through the user output interface of the wireless device.

The wireless device employed in the present method preferably presents promotional messages or advertising from sponsors and/or advertisers. Monetary compensation for the presentation of such advertising material is optionally used to defray or underwrite the costs associated with practice of the present invention. Messages can be in the form of indicia 30 located (e.g., physically imprinted) on devices loaned, rented, sold, or otherwise provided to participants. FIG. 1. Additionally, the messages can be visually displayed by the device or can be aurally communicated through the same. The messages can be in the form of preprogrammed or stored aural or visual messages or recordings that are played, e.g. when the device is powered up or down, or at regular or random intervals during usage of the device. Preferably, messages are transmitted by the wireless communication system and presented live during the entertainment event via open band lines. Visual advertising may be presented in discrete segments interspersed with program content or it may be incorporated substantially continuously into the overall image being presented at a given time, such as a banner advertisement.

In an aspect of the invention, interactive participation using the present method and system is limited to participants who have been enrolled. Such enrollment may be effected by any suitable process carried out either before or during the entertainment event or activity. Optionally, enrollment requires monetary consideration from the person becoming an enrolled participant. Preferably, a participant enrolls by entering suitable information using the wireless interactive device. In some implementations, prospective participants may enroll by a method including a request for enrollment transmitted by telephone, e-mail, interactive registration through an Internet site, regular postal mail, in person at a kiosk or a dedicated terminal provided at the venue. Enrollment can also be effected by responding to signage that is in accordance with the invention. Optionally, the patron is provided with an activation code to be entered using the user input interface of the wireless device. Alternatively, persons having a suitable wireless device with localization circuitry may be identified as being present in the venue and thereafter enrolled automatically or be prompted to accept enrollment, e.g. by exchange of text messages. In other embodiments, participation is limited to persons who have enrolled and who are also identified by wireless device localization circuitry as being physically present at the event venue. Optionally, the participant status is terminated when the individual is no longer present in the venue, but may be restored automatically upon return to the venue. The enrollment may also be for a predetermined time period and expire thereafter. The dissemination of information, such as promotional messages and queries for the interactive contests afforded by the present method, may be limited to participants actually present at the venue.

Preferably, attendants who transmit SMS messages in response to requests on signs, in accordance with the invention, are awarded prizes or other forms of consideration as inducement to participate. Such prizes can include goods and services of any form or discounts toward the purchase thereof. One preferred form for the delivery of such a credit is an electronic coupon that can be redeemed for any form of consideration, including merchandise, services, and/or other prizes available at the venue. Alternatively, coupons redeemable for items or services at no cost or at a reduced cost may be delivered. For example, a message may be transmitted to a user's wireless device bearing a unique authentication code that could be verified by a vendor, such as through a cash register electronically linked to the central processor, or order-processing server, or by a telephone call to a preselected verification number. In other implementations, a graphic image such as a bar code or other like pattern indicative of the coupon is delivered for display on the user's wireless device and read by a suitable reader at a cash register. In still another alternative, a printed coupon can be physically delivered to the participant based on the location of the user's interactive device by means of communication with the transceiver located therein or by other indication means, or delivered to a remote location by actual physical delivery by mail or the like, or by any form of electronic delivery. The coupons may be redeemed with vendors such as fast food delivery restaurants, the on campus bookstore, or other local businesses serving the college campus. Either points or direct monetary credits could also be entered electronically into an account associated with a user, such as a user's credit or debit card, an account for the user's wireless device or Internet service provider, or by other like means known in ordinary commerce. For example, a user collecting sufficient points may redeem them for goods, services, or money. In a preferred embodiment, credits or coupons are transmitted to the winning participant in conjunction with billings for such an account of the participant.

Implementations of the present invention particularly suited for college campuses and related types of venue preferably include dissemination of promotional messages soliciting participants to patronize businesses within the venue, such as the college bookstore. Preferably, the promotional messages also convey coupons or other discount offers that will be presented to the respondents that send the SMS message as required by embodiments of the present invention.

In a further embodiment, the solicitation and querying for services is optionally used also for ordering. For example, a restaurant might solicit business by providing its food and beverage menu by transmission to the participant's wireless interactive device. A hierarchical arrangement of a known sort including submenus may be used in situations wherein more items are available than can be accommodated within the confines of output displays of extant interactive devices. An interested user could then select desired items by navigating using the input interface through the menus to select and order one or more items for purchase, either to be consumed at the restaurant or prepared for take-out. The user is notified when the order is ready or a table is available using his/her wireless interactive device. As hierarchical menu systems have become ubiquitous with the advent of automated teller machines and windowed graphical user interfaces on modern personal computer operating systems, the concept and the method of their use are familiar to many persons and will not be further described here.

Preferably, monetary consideration for purchased items is provided by electronic transfer of funds between bank accounts or by charges billed to a user, such as to a user's conventional debit or credit card or wireless service provider account. Consummation of transactions using other forms of payment known for electronic processing may also be used and are to be considered within the scope of the method of the invention. In one embodiment, the present system is connected to an electronic financial network of a type known in the art. Transfer of funds from the network provides monetary consideration to the provider for the goods and services received by the ordering participant.

Alternatively, any mechanism for effecting electronic payment known in the relevant art is used. As is well understood by those skilled in the art, even the limited hardware display and processing capacity of present cellular telephones, PDA's, and pagers is sufficient to accommodate the aforementioned menu and ordering method. However, as time moves on, much higher text densities and graphics resolution will likely become commonplace in such devices and allow ever-increasing functionality to be provided and used in the method of this invention.

In addition, other services are optionally offered, such as restaurant, lodging and transportation reservations, biographical and recording data for athletes, concert artists, and other performers, future schedules of events, and myriad other information. This information can be conveyed visually, audibly, or via a combination of both media forms. The offerings presented through the wireless interactive device may be complemented by messages simultaneously displayed on video displays, monitors, or the like to enhance their ability to garner the participants' attention.

In an implementation, the present method also comprises querying the participants to respond with answers entered through the user input interface of the wireless device and transmitted therefrom using the wireless communication system. The answers received are transferred to a central processor for processing into results. It will be recognized that the accumulation of results may be done in the central processor or in one or more distributed receiving servers networked in data communication with the central processor by techniques well known in the computer art, such as by use of a local area network communicating over wire, wireless, or fiber optic communication links. Preferably, a stored computer program operative in either form of server accumulates and stores the incoming answers, at least temporarily, as participant data. The results of processing the participant data are also preferably stored, at least temporarily. At a suitable time, such as after the expiration of an announced deadline for participants to enter and transmit their responses to queries, the processed results are then announced to the participants. Optionally prizes are awarded to participants who have entered an answer.

It will be understood that all of the aforementioned computing functions can be carried out by one or more general-purpose computer processors located either within the event venue or its environs, or at a remote location linked by any suitable data communications link using cable, fiber-optic, wireless, or other comparable transmission. The computing functions may be carried out by a single central processor, by linked distributed processors, or a combination thereof. It is also to be understood that the aforementioned computing functions can be implemented in software as an application program tangibly embodied on a program storage device. This stored software can be used in whole or in part in various forms of hardware or special purpose processors, or a combination thereof that comprise applicant's invention.

Requests can be promulgated to the participants in many ways, visual displays such as video monitors of any size, or the like visible to the participants, or by messages via traditional textual or graphic messages transmitted via traditional signage. In some implementations, requests may be printed in event programs, flyers, newspapers, or the like. Optionally the requests can be included in content provided by Internet portal sites to which participants may connect. Preferably, the requests are promulgated using at least one display visible to the participants. More preferably, the visible display comprises large-scale displays and/or monitors provided in the venue. After assimilation and processing of participant responses, announcement of results may be given to the participants by similar means, or by another form of public dissemination, such as an Internet posting.

In one embodiment, a display visible to a sizable number of participants, such as large screen display 40, as depicted in FIG. 2, is used both for promulgating requests to participants and for announcing results. Any one or more large display devices capable of displaying a video, graphic, or alphanumeric image to a large number of participants may be used, a JUMBOTRON® display being one suitable and preferred type. Alternatively, the display visible to the participants comprises plural video monitors such as CRT displays, plasma screens, or the like, preferably dispersed throughout the venue.

In FIG. 2 there is depicted the practice of an embodiment of the invention. At least some of the spectators at an athletic event occurring in a large, outdoor stadium employ an interactive device 10 and 10′. Although FIG. 2 depicts the practice of the present method in a football stadium, it will be understood that the present invention may also be practiced at venues of other types. It will be understood that the interactive device may be an item provided by the participant such as a cellular phone, or a wireless PDA or Pocket PC. Alternatively, suitable general- or special-purpose devices are made available at the spectator venue for purchase or rent or are given away without charge. In still other embodiments, the present system is operative both with user-provided devices and devices made available at the venue. The present inventor contemplates that only a portion of the persons present in a venue may choose to participate, either by using a suitable general-purpose interactive device they furnish or by obtaining a specialized unit at the venue. FIG. 2 further depicts the users entering answers to a query using keypads available on their respective interactive devices and the display of answers on a large display board 40. In addition to displaying results of the audience querying or contest, the material displayed on board 40 or dispersed video monitors optionally also includes promotional messages or advertising. For example, a given contest question might be sponsored by a business entity in return for including advertising for the entity's products or services during the querying and announcing associated with that contest.

Optionally, the responses of the participants are sent to a central processor (not shown) having a computer program stored and operative therein that is adapted to tabulate the responses. Then, the processed information is stored and displayed to the audience member, on either the device 10 or a remotely located large screen display 40. FIGS. 1 and 2. The processed information could be a compilation or tabulation of similar responses, as either a number or a percentage of total responses, a graphical representation in a bar chart, pie chart or the like, or a combined graphical and numerical representation of the data. The processing further may include categorization of participants' responses according to demographic characteristics, which might include the age or gender of the participant.

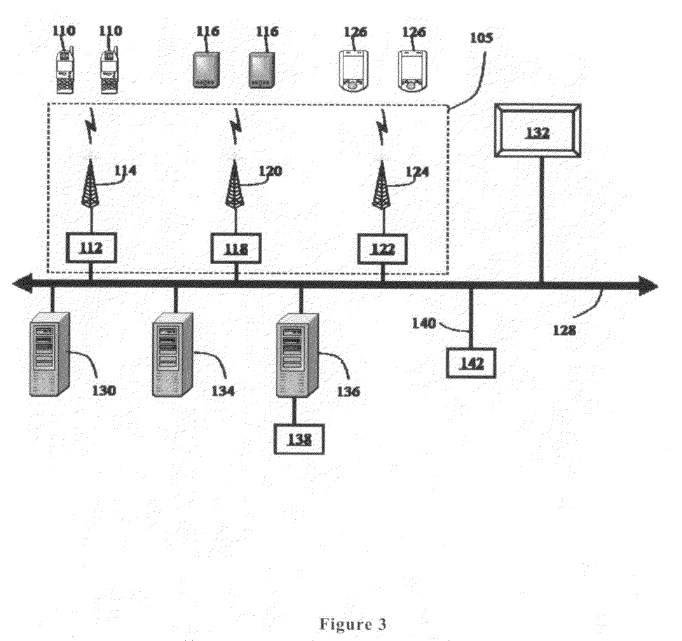

FIG. 3 depicts one implementation of a system in accordance with the present invention. A wireless communications system 105 provides service to cellular telephones, wireless PDA's, and Pocket PC's. Wireless, or wired (not shown) interactive devices that can be used with the system are a plurality of cellular telephones 110 and, which are served by cellular telephone provider 112 through signals transmitted and received at antenna 114. Wireless PDA's 116 are served by wireless PDA service provider 118 through signals transmitted and received at antenna 120. A wireless local area network 122 transmitting signals in accordance with one of the levels of IEEE Standard 802.11 from antenna 124 serves wireless Pocket PC's 126. Each of cellular telephone provider 112, wireless PDA service provider 118, and wireless local area network 122 communicates through the Internet 128. An exemplary wired interactive device can be presented to a user via the internet to a user logged onto, e.g., a on/off campus, or casino, computer connected to the network 122 using for example an ethernet or token ring connection. The user interface can be presented to the user via a web browser. Such a user interface can allow interaction with applicant's system 100 as if the user were using a wireless Pocket PC 126 or other device capable with wirelessly connecting to the applicant's system 100.

Enrollment server 150 is used to receive messages transmitted from interactive devices 110, 116, and 126 or otherwise requesting enrollment. Promotional message server 130 selects promotional messages, which are transmitted via the Internet to wireless communications system 105, and broadcast to interactive devices 110, 116, and 126. Promotional messages are also transmitted to a large video display 132, which includes a controller operative to receive digital information, e.g. information received via the Internet, and convert it into corresponding textual, graphic, or video displays for presentation. Central processor 134 provides queries displayed on display 132. Answers to such queries are entered on the user input interfaces of interactive devices 110, 116, and 126 and received by distributed receiving servers (not shown) maintained by each of cellular telephone provider 112, wireless PDA service provider 118, and wireless local area network 122. The distributed receiving servers accumulate the answers and transfer them by Internet to central processor 134 for processing into results, which are then communicated and displayed by display 132. Order processing server 136 receives orders for goods and services entered by participants using their wireless interactive devices, and communicates those orders to one or more providers 138 of goods and services, such as food/beverage vendors. Connection 140 to electronic financial network 142 enables the electronic transmission to providers 138 of monetary consideration for the goods and services they furnish. Enrollment server 140 acts in concert with central processor 134 and promotional message server 130 in the selection of promotional messages and queries and the enrolled participants to whom such communications are sent.

It will be understood by those skilled in the relevant art that the functions of the plural servers alternatively may be shared among a smaller number of servers or may be accomplished by central processor 134. The plural servers also may be in data communications via the Internet or a local network implemented using connections by wire, wireless, or optical data transmission, in any way conventional in the art. Other networking protocols suitable for the interchange of digital information may also be used.

Applicant's invention can be implemented by specialized software program tangibly embodied on a program storage device. The software can access and present various forms of data, including but not limited to, images, audio clips, videos and user interfaces, e.g., html forms and other html pages that are tangibly embodied on a program storage device. Such data can be in directly and tangibly embodied in a program storage device or may take the form of software code that can construct such data in a just in time fashion e.g. using Perl scripts or cgi-bin programming.

Applicant's invention can also be implemented using one or more application program interfaces (APIs), which can allow access to different aspects of the system. Such APIs, in accordance with applicant's invention, can take the form of specifications that can be used by developers of various devices and networks used in applicant's invention communicate with each other and what functions each device must carry out. An API, in accordance with applicant's invention, can also be a set of functions that different devices can use to interface with applicant's invented system.

In an exemplary embodiment, the APIs can be implemented to allow different types of access to the applicants system based on the needs of the intended user (it should be noted that the intended user can be an actual living being, a software method being executed by a device in communication with applicant's system). Consider, for example, an API intended for use in a user device in accordance with applicant's invention. Such an API might contain facilities that allow a user to login in, access and change various preferences and identity information. The API may also comprise a facility to present to the user various user interfaces at various times. The API could allow for the collection and processing of user input. After appropriate processing, the API could facilitate the transmission of such data to one or more devices connected to applicant's system, e.g. an enrollment server or another user's device. The API could also allow for the reception and processing of various communications, received from those devices.

Another exemplary API can be used to implement an interface to applicant's system for various advertisers. Such an API could have functions that, for example, allow monitoring various aspects of the instant event, interactions of one or more users. The API would also allow the various advertisers to submit messages to be transmitted to users, and define the characteristics of users to whom one or more messages are supposed to be sent. The API could also allow advertisers, and other interested parties, to develop their own specialized auction interfaces that can be used in accordance with the present invention and implementations thereof. The API could also allow access to a database containing information gathered from the users that has been cleaned and ready for data mining. Such an API might allow an advertiser to easily integrate communication with their system and applicant's invention. This could allow an advertiser to develop their own automated application that can automatically select and send appropriate advertisements to individual user devices without having to contact an intermediary agent. Such an API could advantageously allow an advertiser to subscribe to the system, possibly through an intermediary agent, and then allow the advertiser instantaneous access to user devices “in real-time” as the event progresses at one or more venues.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A system for data collection, and the processing there of, from attendants of a live entertainment event at a venue and employing a wireless interactive device capable of (i) receiving and transmitting messages, (ii) accepting input via a user interface, and (iii) displaying messages on an electronic display, the system comprising:
a sign that presents to one or more of the attendants a message with a request to respond back via the user interface, the request being transmitted by the interactive device;
a receiving device that receives the responses at a central processing station or distributed processing stations;
a storage device that stores the received responses as attendant data;
a central processor adapted to process the stored attendant data into efficacy data for the sign; and
wherein one or more of the attendants is located at the venue.

2. A system as defined by claim 1, wherein one or more of the attendants is physically at a place that is inside of a direct, in person view of the live entertainment event at the venue.

3. A system as defined by claim 1, wherein one or more of the attendants is physically at a place that is outside of a direct, in person view of the live entertainment event at the venue.

4. A system as defined by claim 1, wherein one or more of the attendants is physically at the venue.

5. A system as defined by claim 1, wherein the venue is an airport.

6. A system as defined by claim 1, wherein the venue is a movie theater.

7. A system as defined by claim 1, wherein the sign is presented on an electronic display.

8. A system as defined by claim 3, wherein the place is a concession stand.

9. A system as defined by claim 3, wherein the place is a restroom.

10. A system as defined by claim 3, wherein the place is a parking lot that services the venue.

11. A system as defined by claim 3, wherein the place is a remote stadium.

12. A system as defined by claim 3, wherein the place is a convention hall.

13. A system as defined by claim 3, wherein the place is a restaurant.

14. A system as defined by claim 3, wherein the place is a bar.

15. A system as defined by claim 3 wherein the place is a house.

16. A system as defined by claim 15 wherein the place is a restroom within the house.

17. A system as defined by claim 15, wherein the place is a living room within the house.

18. A system as defined by claim 15, wherein the place is a kitchen within the house.

19. A system as defined by claim 15, wherein the place is a bedroom within the house.

20. The system as defined by claim 1, further comprising a transmitter for transmitting a subset of the data to an entity.

21. A system as defined by claim 20, wherein, the data is the attendant data.

22. A system as defined by claim 20, wherein, the data is the efficacy data.

23. A system as defined by claim 20, wherein the entity is an event sponsor.

24. A system as defined by claim 20, wherein the entity is an advertising sponsor.

25. A system as defined by claim 20, wherein the entity is a processing entity that will process the data.

26. A system as defined by claim 1, further comprising means for disseminating at least one promotional message of a sponsor to the attendants through the electronic display.

27. A system as defined by claim 1, wherein the sign comprises at least one large screen display visible to attendants in the venue.

28. A system as defined by claim 1, wherein the sign comprises a venue monitor system visible to attendants in the venue.

29. A system as defined by claim 1, further comprising at least one prize appointed to be awarded to at least one of the attendants.

30. A system as defined by claim 1, further comprising a wireless communications system adapted to transmit and receive messages with the interactive device, wherein the wireless communications system transmits and receives using at least one transmission form selected from the group consisting of radio transmission, microwave transmission, broadband wireless data transmission, ultra-wide band transmission, and satellite transmission.

31. A system as defined by claim 1, further comprising means for broadcasting messages from the interactive device of one of the attendants to the interactive device of another of the attendants.

32. A system as defined by claim 1, wherein each of the interactive devices has a unique address programmed therein.

33. A system as defined by claim 1, further comprising means for providing audio transmission of audible programming to the interactive devices, the audible programming comprising at least one of play-by-play, expert commentary, traffic reports, and weather reports.

34. A system as defined by claim 1, wherein the venue is selected from the group consisting of stadiums, arenas, race tracks, golf courses, and theme parks.

35. A method for data collection, and the processing thereof, from attendants of a live entertainment event at a venue and employing a wireless interactive device that is capable of (i) receiving and transmitting messages, (ii) accepting input via a user interface, and (iii) displaying messages on an electronic display, comprising the steps of:
posting a sign that presents to one or more of the attendants a message with a request to respond back via the user interface, the request being transmitted by the interactive device;
receiving the responses at a central processing station or distributed processing stations;
storing the received responses as attendant data;
processing the stored attendant data into efficacy data for the sign; and
one or more of the attendants being located at the venue

36. A method as defined by claim 35, wherein one or more of the attendants is physically at a place that is inside of a direct, in person view of the live entertainment event at the venue.

37. A method as defined by claim 35, wherein one or more of the attendants is physically at a place that is outside of a direct, in person view of the live entertainment event at the venue.

38. A method as defined by claim 35, wherein one or more of the attendants is physically at the venue.

39. A method as defined by claim 35, wherein the venue is an airport.

40. A method as defined by claim 35, wherein the venue is a movie theater.

41. A method as defined by claim 35, wherein the sign is presented on an electronic display.

42. A method as defined by claim 37, wherein the place is a concession stand.

43. A method as defined by claim 37, wherein the place is a restroom.

44. A method as defined by claim 37, wherein the place is a parking lot that services the venue.

45. A method as defined by claim 37, wherein the place is a remote stadium.

46. A method as defined by claim 37, wherein the place is a convention hall.

47. A method as defined by claim 37, wherein the place is a restaurant.

48. A method as defined by claim 37, wherein the place is a bar.

49. A method as defined by claim 37 wherein the place is a house.

50. A method as defined by claim 49 wherein the place is a restroom within the house.

51. A method as defined by claim 49, wherein the place is a living room within the house.

52. A method as defined by claim 49, wherein the place is a kitchen within the house.

53. A method as defined by claim 49, wherein the place is a bedroom within the house.

54. The method as defined by claim 35, further comprising a transmitter for transmitting a subset of the data to an entity.

55. A method as defined by claim 54, wherein, the data is the attendant data,

56. A method as defined by claim 54, wherein, the data is the efficacy data.

57. A method as defined by claim 54, wherein the entity is an event sponsor.

58. A method as defined by claim 54, wherein the entity is an advertising sponsor.

59. A method as defined by claim 54, wherein the entity is a processing entity that will process the data.

60. A method as defined by claim 35, further comprising step of disseminating at least one promotional message of a sponsor to the attendants through the electronic display.

61. A method as defined by claim 35, wherein the sign comprises at least one large screen display visible to attendants in the venue.

62. A method as defined by claim 35, wherein the sign comprises a venue monitor system visible to attendants in the venue.

63. A method as defined by claim 35, further comprising the step of appointing at least one prize to be awarded to at least one of the attendants.

64. A method as defined by claim 35, wherein the wireless interactive device employs a form of wireless communications selected from the group consisting of radio transmissions, microwave transmissions, broadband wireless data transmissions, and satellite transmissions

65. A method as defined by claim 35, further comprising the step of broadcasting messages from the interactive device of one of the attendants to the interactive device of another of the attendants.

66. A method as defined by claim 35, wherein each of the interactive devices has a unique address programmed therein.

67. A method as defined by claim 35, further comprising the step of providing audio transmission of audible programming to the interactive devices, the audible programming comprising at least one of play-by-play, expert commentary, traffic reports, and weather reports.

68. A method as defined by claim 35, wherein the venue is selected from the group consisting of stadiums, arenas, race tracks, golf courses, and theme parks.

69. A method for auctioning advertising space, comprising the steps of:
collecting raw data about the instantaneous efficacy of one or more sign placement locations;
transmitting the data to one or more bidders as it is collected;
transmitting one or more initial auction parameters and subsequent changes to those auction parameters to the bidders;

70. A method as defined in claim 69, further comprising the step of receiving one or more bids from a number of the bidders.

71. A method as defined in claim 70, further comprising the step of selecting the highest bidder as a winner at the end of a period of time.

72. A method as defined in claim 71, further comprising the step of displaying a message selected by the winner at the sign placement location.

73. A method as defined in claim 69 wherein, the sign placement locations are at a venue during a live event.

74. A method as defined in claim 69, wherein the step of collecting the raw data further comprises, processing one or more subsets of the raw data before transmission; and
wherein, the step of transmitting the data transmits the processed data.
